(19) United States
(12) Patent Application Publication
(10) Pub. No.: US 2015/0081551 A1
(43) Pub. Date: Mar. 19, 2015

(54) METHODS AND SYSTEMS FOR MAKING SECURE PAYMENTS

(71) Applicant: NETFIN WORKS INFORMATION TECHNOLOGY (SHANGHAI) CO., LTD., Shanghai (CN)

(72) Inventor: QIANGHUA YU, Shanghai (CN)

(73) Assignee: NETFIN WORKS INFORMATION TECHNOLOGY (SHANGHAI) CO., LTD.

(21) Appl. No.: 14/487,260

(22) Filed: Sep. 16, 2014

(30) Foreign Application Priority Data
Sep. 18, 2013 (CN) 103489104A

(51) Int. Cl. G06Q 20/40

(52) U.S. Cl. CPC G06Q 20/401
USPC 705/44

(57) ABSTRACT

A method and system for making secure payments are disclosed. A service terminal of a buyer's bank may implement the method for secure payment. The service terminal may receive a request for payment from a buyer, the request including a name of a seller and a payment amount; approve the request for payment; withhold the payment amount; and generate a proof of payment. Further, the service terminal of the buyer's bank may store the proof of payment, an expiration date of the proof of payment; send the proof of payment to the buyer; and receive a withdrawal request from a seller's bank. The withdrawal request includes the name of the seller and the payment amount. Finally, the service terminal of the buyer's bank may release the payment based on the withdrawal request.

### CROSS-REFERENCES TO RELATED APPLICATIONS

### Related Applications

This application is based upon and claims the benefit of priority from Chinese Patent Application No. CN103489104A filed on Sep. 18, 2013, the entire content of which is incorporated herein by reference.

### FIELD OF THE TECHNOLOGY

The present disclosure relates to network technologies and, more particularly, to methods and systems for making secure payments online.

### BACKGROUND

With the development of internet related technologies, online payment has been used routinely by users. However, it is also common for users to hear about online data fraud or data leaks by financial organizations. As such, the security of online payment systems has become more and more important. The current online payment methods include the SSL (Secure Socket Layer) protocol, the SET protocol, the 3D-secure protocol, the Directpay protocol, etc. Each of the commonly used payment method has its own issues. Below introduces the basics of the commonly used secure payment protocols.

The SSL protocol was first developed by Netscape as a secure email communication protocol. The SSL protocol encodes communications between different computers. The protocol includes an encryption process, an authentication process, and an integrity checking process. FIG. 1 provides an exemplary flow chart of an online payment process using the SSL protocol. In various e-commerce transactions, based on the participation of banks and the SSL protocol, a buyer's purchase information is first sent to the seller. The seller may then send the information to its bank. The bank may verify the purchase information and inform the seller that the payment process is successful. The seller may then inform the buyer that the purchase is complete and send the purchased products to the buyer. The integrity of the online payments made through the SSL protocol relies on the integrity of the seller. In this process, the seller may obtain a credit card or other bankcard number and the related passcode from the buyer. As online commerce becomes widely accepted, there are more and more online sellers. This makes it hard to ensure the quality of the sellers and increases the possibility of fraudulent use of the buyer data.

The SET protocol is developed by the two largest credit card companies VISA and MasterCard in May 1997. FIG. 2 shows an exemplary flow chart of an online payment process using the SET protocol. The SET protocol is primarily developed to solve problems related to how a consumer makes a purchase from a seller using credit cards. The SET protocol ensures the confidentiality of payment information, the integrity of the payment process, the identities of the buyer and seller, and the operability of the payment protocol. The SET protocol is one of the better-developed and widely used payment methods in e-commerce. One of the problems of the SET protocol is the complexity of the method. Using the SET protocol, in a typical transaction, the users may need to authenticate the electrical certificate nine times, authenticate the digital signature six times. An online transaction using the SET protocol may take 1-2 minutes to complete. Further, the SET protocol is directed to credit cards, not debit cards.

The 3D-Secure (Three-Domain Secure) is a protocol that is developed by VISA to improve e-commerce and the related network trading environment. The 3D-Secure protocol also has a few problems. First, a user may visit a seller's website using a user terminal. In the payment process, the buyer's credit card number may be obtained by VISA, the seller, or the payment-receiving bank, which increases the risk of phishing by third parties. Further, the payment process is handled in a web browser, which may have an increased risk of being hacked by malicious parties.

Directpay is a protocol developed by the American Automated Clearing House (ACH). The goal of Directpay is to enable owners of bank accounts to use ACH credits to securely move payments from the ACH network into the seller's bank. FIG. 3 shows an exemplary flow chart of an online payment process using the Directpay protocol. This protocol has some of the issues similar to the other protocols, including a seller obtaining a buyer's credit card number, multiple times of verification of electronic certificates, etc.

In the current online trading environment, over 95% of the security problems are related to hacker attacks and fraudulent transactions. Hacker attacks refer to when a hacker intercepts information, invades into a payment system, and tricks a user to provide his information, such as the user's account number and password. The hacker may then use the account number and password to log into a user's account to steal funds. In the trading process consistent with the present disclosure, often, only a proof of payment is transferred, which decreases the risk of hacker attacks. Even if a hacker intercepts a user's account and password, the buyer's bank may still check the last login time of the buyer's user terminal, the IP address of the buyer's user terminal, and other information unique to the buyer's user terminal. If a hacker does not have such information, he still cannot move the funds.

Fraudulent transactions refer to the situations in which a seller poses as a buyer and initiates fraudulent transaction requests to the buyer's bank. In certain situations, the buyer's bank may verify with the buyer before making a transaction. However, the seller may later pose as the buyer again to attempt to move funds fraudulently. In the trading process consistent with the present disclosure, a request for payment is submitted by the buyer before a buyer's bank confirms the transaction with the seller. Further, the request for payment does not go through the seller, which prevents untrustworthy sellers from intercepting information for fraudulent use.

The disclosed method and system are directed to solve one or more problems set forth above and other problems.

### BRIEF SUMMARY OF THE DISCLOSURE

Embodiments consistent with the present disclosure provide a method, system, mobile device, or a server for making secure payments.

One aspect of the present disclosure provides a method and system for making secure payments. A service terminal of a buyer's bank may implement the method for making secure payments. The service terminal may receive a request for payment from a buyer, the request including a name of a seller and a payment amount; approve the request for payment; withhold the payment amount; and generate a proof of payment. Further, the service terminal of the buyer's bank may store the proof of payment, an expiration date of the proof of payment; send the proof of payment to the buyer; receive a withdrawal request from a seller's bank, the withdrawal request including the name of the seller and the payment amount; and release the payment based on the withdrawal request.

Another aspect of the present disclosure provides a method and system for making secure payments. A system for secure payment includes a buyer user terminal, a service terminal of the buyer's bank, a seller user terminal, and a service terminal of the seller's bank. The buyer terminal is configured to send a request for payment to the buyer's bank, the request including a name of a seller and a payment amount. The service terminal of the buyer's bank is configured to approve the request for payment. The service terminal of the buyer's bank is further configured to withhold the payment amount, generate a proof of payment, store an expiration date of the proof of payment; and send the proof of payment to the buyer. The user terminal of the buyer is configured to send the proof of payment to the user terminal of the seller.

The user terminal of the seller is configured to send the proof of payment to the service terminal of the seller's bank. The service terminal of the seller's bank is configured to send a withdrawal request, the withdrawal request including the proof of payment, the name of the seller and the payment amount. The service terminal of the buyer's bank is configured to move the buyer's funds based on the withdrawal request. The service terminal of the seller's bank is configured to inform the user terminal of the seller that the payment is fulfilled.

Another aspect of the present disclosure provides a method and system for making secure payments. A system for secure payments includes a buyer user terminal, a service terminal of the buyer's bank, a seller user terminal, and a service terminal of the seller's bank. The service terminal of the seller's bank is configured to receive a proof of payment from the user terminal of the seller, the proof of payment including a name of the seller and a payment amount; send the proof of payment to the service terminal of the buyer's bank; request withdrawing the payment amount; receive a message from the service terminal of the buyer's bank, indicating the withdrawal is complete; and send a message to the user terminal of the seller, indicating the payment is complete.

Further, the service terminal of the buyer's bank is configured to determine whether to release the payment based on the withdrawal request. The proof of payment includes a buyer bank ID and a random sequence number. The buyer, using a user ID and a password, may log into a secure payment system before sending the payment request.

The buyer's bank determines whether the request for payment is approved based on the user ID and password. Moreover, the buyer's bank requires information unique to a user terminal of the buyer. The buyer's bank may then approve the request for payment based on the user ID, the password, and the information unique to the user terminal of the buyer. The information unique to the user terminal of the buyer includes an IP address of the user terminal of the buyer, a previous log-in time of the buyer, a random number sequence stored in the user terminal of the buyer, a mobile phone number, an MAC address, or a combination thereof.

Other aspects of the present disclosure can be understood by those skilled in the art in light of the description, the claims, and the drawings of the present disclosure.

### BRIEF DESCRIPTION OF THE DRAWINGS

To illustrate embodiments of the invention, the following are a few drawings illustrating embodiments consistent with the present disclosure.

FIG. 1 is a flow chart of a payment process based on the SSL protocol;

FIG. 2 is a flow chart of a payment process based on the SET protocol;

FIG. 3 is a flow chart of a payment process based on the Directpay protocol;

FIG. 4 is a flow chart of a secure payment process consistent with the present disclosure; and

FIG. 5 is a block diagram of a secure payment system consistent with the present disclosure.

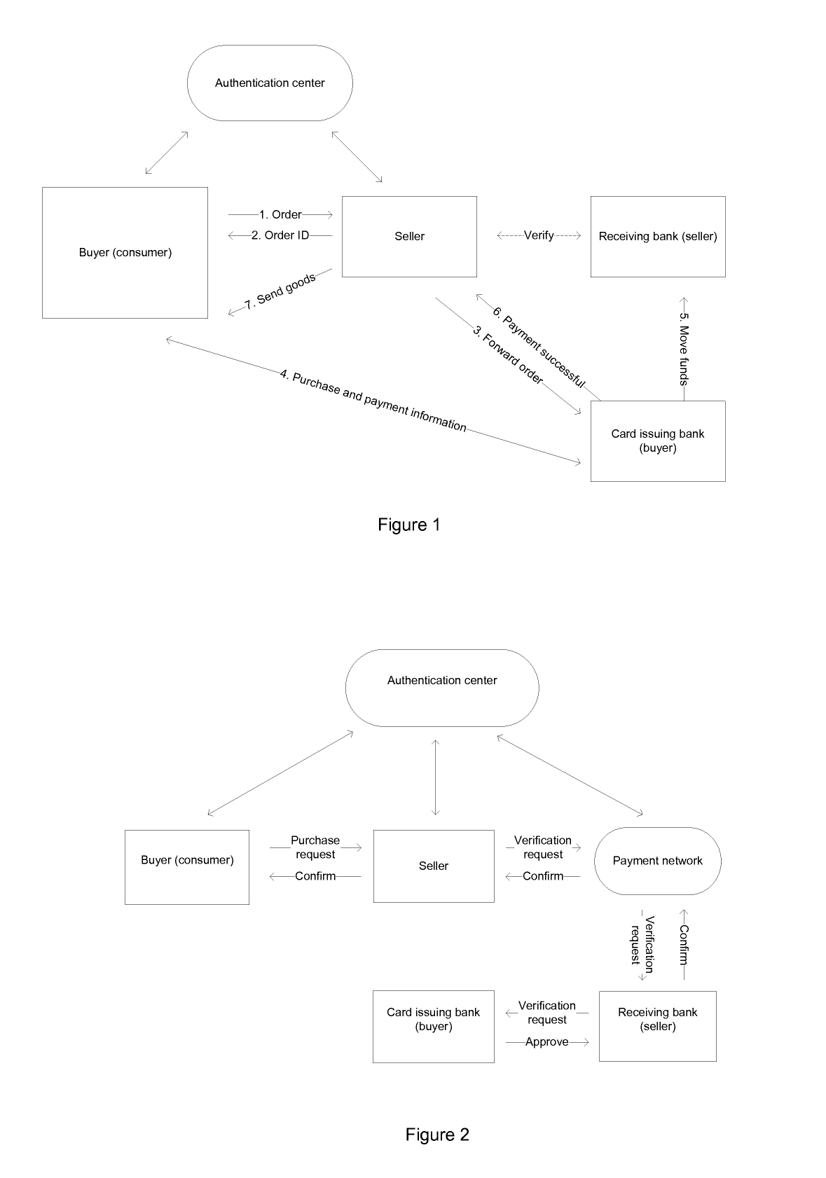

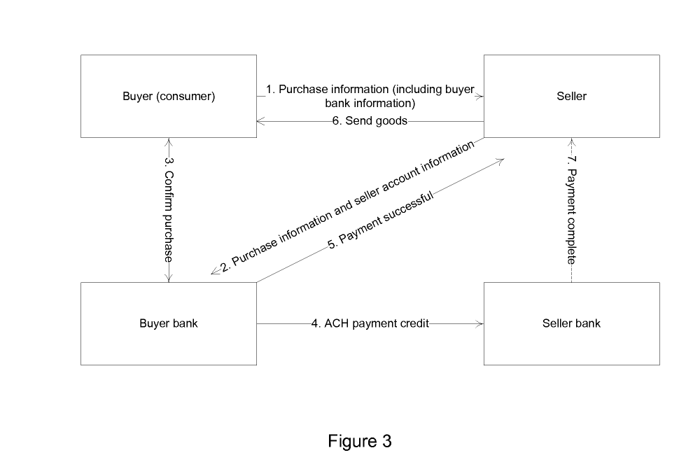

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

Embodiments consistent with the present disclosure provide a system for making secure payments. The secure payment system may offer an option (through a user interface) for the user to select whether he would share his bank account data with a seller when making an online purchase. If the buyer chooses not to share his bank account data, the system may execute steps S1-S13 as described below. In addition, the system for making secure payments may execute steps S1-S13 automatically after a buyer makes an online purchase and makes the request for making a secure payment. That is, the buyer may initiate the process outlined in steps S1-S13 when he completes an online purchase. The secure payment system may then implement the secure payment process without further user input.

A secure payment system consistent with the present disclosure may support a secure payment process using data structures based on a proof of payment. The proof of payment may include an ID of an entity (e.g., a buyer's bank) that issued the proof of payment and a number that can be used to identify the specific proof of payment. The proof of payment may be encrypted when transferred between different entities. The proof of payment may also be associated with an expiration date.

A secure payment system consistent with the present disclosure may support a secure payment process using data structures based on a proof of payment and information unique to a user terminal. When a buyer requests that a payment be made, the buyer's bank may retrieve information unique to the user terminal to authenticate the buyer. The information unique to a user terminal includes an IP address of the user terminal, a previous login time of the user terminal, etc. After the buyer's bank authenticates the user terminal of the buyer, it may then issue a proof of payment to the user terminal.

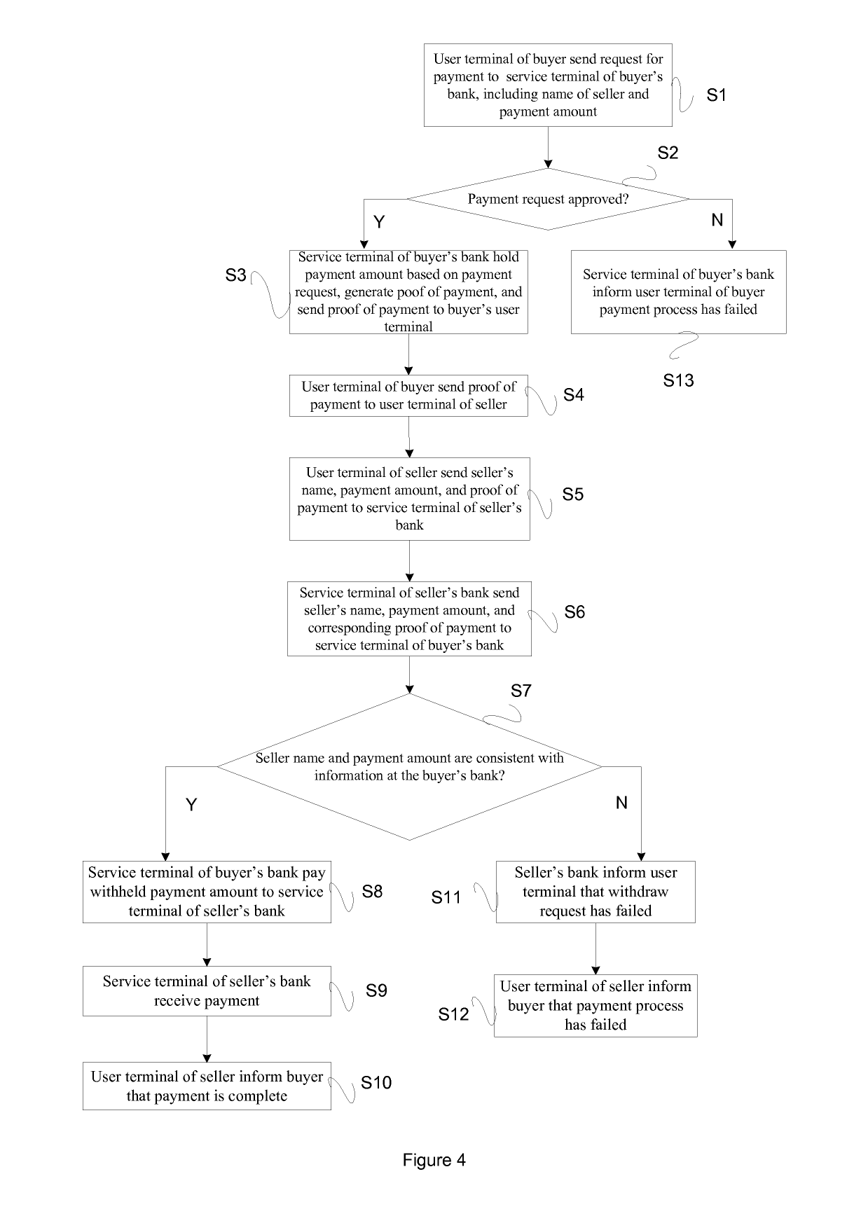

FIG. 4 shows a flow chart of a secure payment method for online transactions consistent with the present disclosure. Embodiments consistent with the present disclosure do not require the buyer to share his account information with the seller. Instead, the service terminal of the buyer's bank sends a proof of payment to the seller's user terminal. The seller's user terminal may then use the proof of payment to collect the payment. Further, the service terminal of the buyer's bank does not need to exchange information with the seller's user terminal. The seller, through his bank's service terminal, collects the payment from the buyer's bank. The method shown in FIG. 4 includes steps S1-S13.

In step S1, the user terminal of a buyer sends a request for payment to the service terminal of the buyer's bank. The request includes a name of a seller and a payment amount. Specifically, once the buyer selects the product for a purchase, the buyer may send a request for payment to his bank. The service terminal of the buyer's bank may be the service terminal associated with the buyer's bank account or the service terminal associated with the account number from which the buyer's bank sends funds out to other organizations. For example, if a buyer uses PayPal to make payments, the service terminal of the buyer's bank may refer to the service terminal of PayPal. Similarly, the service terminal of the seller's bank may be the service terminal associated with the seller's bank account or the service terminal associated with the account number from which the seller's bank receives funds from other organizations. For example, if a seller uses a third party account to receive buyer payments, the service terminal associated with the third party account may be referred to as the service terminal of the seller's bank.

In one embodiment, the user terminal of the buyer may use the buyer's account and password to log into a secure payment system and send a request for payment to the buyer's bank. The request includes the identification of the seller and the payment amount requested.

In step S2, the service terminal of the buyer's bank may determine whether the payment request is approved. If so, the secure payment system may execute step S3. Otherwise, the secure payment system may execute step S13.

In one embodiment, in step S2, the service terminal of the buyer's bank may use the received buyer account number and password to determine whether the payment request should be approved. In another embodiment, in step S2, the service terminal of the buyer's bank may obtain certain information unique to the buyer's user terminal. The service terminal of the buyer's bank may use the received buyer account number, password, and unique user terminal information to determine whether the payment request should be approved.

The unique user terminal information may include the IP address of the user terminal, the previous logging-in time of the user terminal, the serial number of the user terminal, a pre-set random number stored in the user terminal, the mobile phone number of the user terminal (if the user terminal is on a mobile phone), the MAC address of the user terminal (if the user terminal is on a PC), or any combination thereof. Specifically, when the user terminal of the buyer requests a payment from the buyer's bank, other than encryptions and signatures, the buyer's bank may request the user terminal to provide information unique to the user terminal. The unique information may be the IP address of the user terminal, the previous logging-in time of the user terminal, etc. If the user terminal unique information is not consistent with the information stored at the service terminal of the buyer's bank, the bank may send a message to the user terminal, indicating the request for payment has been rejected.

In embodiments consistent with the present disclosure, even if a hacker obtains a buyer's account number and password, because it would not be able to provide the information unique to the buyer's user terminal, the hacker would not be able to withdraw funds from the buyer's account. The information unique to the user terminal may be entered by the buyer upon request or may be stored in the user terminal of the buyer and be retrieved by the service terminal of the buyer's bank.

In step S3, the service terminal of the buyer's bank may hold the payment amount based on the payment request, generate a poof of payment, and send the proof of payment to the buyer's user terminal. The buyer's bank may further store the expiration date of the proof of payment, name of the seller, payment amount, etc. Specifically, in embodiments consistent with the present disclosure, only the proof of payment is transferred among different entities. The buyer's account number and other information are not transferred to the seller or the seller's bank. Further, the proof of payment expires on the expiration date. Thus, embodiments consistent with the present disclosure improve the security of the buyer's information and the payment process.

In some embodiment, the proof of payment includes identification for a buyer's bank and a random number sequence. For example, a proof of payment may include a 32-digit number. The first 16 digits may represent the identification of the buyer's bank. The second 16 digits may be a random number. The service terminal of the buyer's bank may generate a record using the proof of payment as the primary key. The record may also include the expiration dates for the proof of payment and for the buyer's funds. The record may further include the name of the seller and the payment amount. The service terminal of the buyer's bank may encrypt the proof of payment and send it to the seller's user terminal. In subsequent steps, the service terminal of the seller's bank may send a request to fulfill the payment to the service terminal of the buyer's bank based on the first 16 digits of the 32-digit number (the buyer's bank ID). The request to fulfill payment may include the payment amount of the seller's name.

In step S4, the user terminal of the buyer sends the proof of payment to the user terminal of the seller. Specifically, the user terminal of the buyer may use a secure channel, such as https, to send the proof of payment to the seller. In step S5, The user terminal of the seller may send the seller's name, payment amount, and the proof of payment to the service terminal of the seller's bank. Specifically, the user terminal of the seller may send the seller's name, payment amount, and the proof of payment to the service terminal of the seller's bank using a secure channel (e.g., https). The user terminal of the seller may thus request payment fulfillment.

In step S6, the service terminal of the seller's bank may send the seller's name, payment amount, and the corresponding proof of payment to the service terminal of the buyer's bank. In some embodiments, in step S6, the service terminal of the seller's bank may send the seller's name, payment amount, and the corresponding proof of payment to the service terminal of the buyer's bank using the ID of the buyer's bank.

The current payment methods require the user terminal of the seller to exchange information with the buyer's bank. The buyer's bank may then authenticate the seller. This increases the complexity of the payment process. However, if the buyer's bank does not authenticate the seller, the buyer's bank would not know that the seller is genuine and the information from the seller is reliable. However, in embodiments consistent with the present disclosure, the buyer's bank does not need to exchange information with the seller and does not need to authenticate the seller.

In step S7, the service terminal of the buyer's bank may check the proof of payment to determine the name of the seller, and the payment amount based on the data sent by the service terminal of the seller's bank. If the seller name and payment amount are consistent with the information at the buyer's bank and the proof of payment has not expired, then the system executes step S8. Otherwise, the system executes step S11. Specifically, when the service terminal of the seller's bank withdraws the payment from the service terminal of the buyer's bank, the buyer's bank may then authenticate the withdrawal request by checking the payment amount, seller name, etc. If the information in the withdrawal request is inconsistent with the seller name and payment amount stored in the buyer's bank, the buyer's bank may send a message indicating that the withdrawal has failed. In this case, even if a hacker obtains the proof of payment from a network attack, if the hacker does not have the corresponding seller name and payment amount, he still cannot withdraw the funds.

In step S8, the service terminal of the buyer's bank may pay the withheld payment amount to the service terminal of the seller's bank. Specifically, after the service terminal of the buyer's bank receives the proof of payment, it may look up the proof of payment in its database. After the service terminal of the buyer's bank check to verify that the withdrawal request has the same seller name and payment amount, it may then send the payment to the service terminal of the seller's bank. After the payment is withdrawn, the service terminal of the buyer's bank may create a record and store the record in the database, indicating that the withdrawal is complete.

In step S9, the service terminal of the seller's bank receives the payment. The seller's bank may inform the user terminal of the seller that the payment is received. In step S10, the user terminal of the seller may inform the buyer that the payment is complete. In step S11, the seller's bank may inform the user terminal that the withdrawal request has failed. In step S12, the user terminal of the seller informs the buyer that the payment process has failed. In step S13, the service terminal of the buyer's bank may inform the user terminal of the buyer that the payment process has failed.

In some embodiments, encryptions and signatures may be applied to the communications between the user terminal of the buyer and the buyer's bank, between the user terminal of the buyer and the user terminal of the seller, between the user terminal of the seller and the seller's bank, and between the seller's bank and the user terminal of the buyer. This is to ensure that the information transferred between the different entities is secure and reliable. When the buyer opens an account at the buyer's bank, the user terminal of the buyer and the service terminal of the buyer's bank may exchange a security key, which may subsequently be used to encrypt information transferred between the user terminal and the bank.

In current payment methods, the user terminal of a seller contacts the buyer's bank to withdraw the payment. To implement this step successfully, the buyer has to provide its account information to the user terminal of the seller. This creates an opportunity for “malicious sellers” to intercept and change the buyer information. Even though the present payment methods employ various encryptions and signatures to increase the security level, the present methods are often either too complex (slow to execute) or do not provide enough security. Further, the service terminal of the buyer's bank needs to authenticate the user terminal of the seller by executing a number of steps. As the volume of online transactions increases, the buyer's bank may need to be able to authenticate a large number of sellers. A new seller, for example, may not have any data record at the buyer's bank. This may increase the burden on the buyer's bank to acquire and manage a large amount of data related to sellers.

In embodiments consistent with the present disclosure, the buyer's bank only needs to receive the payment request from the user terminal of the buyer. The buyer's bank later receives the withdrawal request from the user terminal of the seller. The seller's bank only needs to exchange information with the seller. Such processes make it easy for the banks to verify the users' identities. That is, the buyer's bank can authenticate the buyer easily and the seller's bank can authenticate the seller easily. This is because when a user opens an account with his bank, there are many ways for the two parties to set up ways of authentication. Further, the buyer's bank and the seller's bank should also be able to authenticate each other easily, as the banks are often very large entities. The authentication between the two banks may be done directly or through a third party. As such, the payment process consistent with the present disclosure provides an easy way to authenticate various parties.

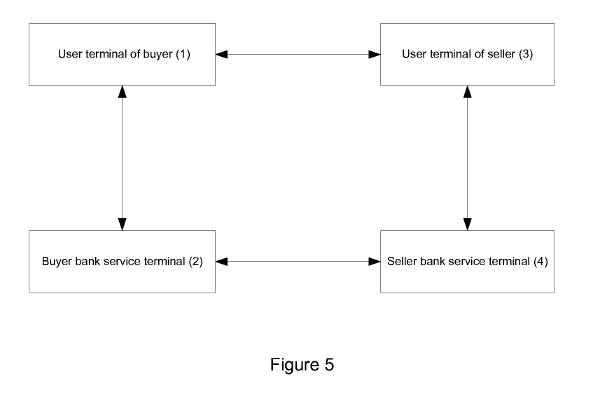

FIG. 5 shows a block diagram of a system for secure payment consistent with the present disclosure. In FIG. 5, the system for secure payment includes a user terminal of the buyer 1, a service terminal of the buyer's bank 2, a user terminal of the seller 3, and a service terminal of the seller's bank 4.

In one embodiment, the user terminal of the buyer 1 may use the buyer's account and password to log into the secure payment system and send a request for payment to the buyer's bank 2. The request includes the identification of the seller and the payment amount requested. The service terminal of the buyer 1 may further receive a proof of payment from the buyer's bank 2. The service terminal of the buyer 1 may send the proof of payment to the service terminal of the seller 3.

The service terminal of the buyer's bank 2 may determine whether it should approve the payment request. If so, the service terminal of the buyer's bank 2 may withhold the payment amount from the buyer's account and generate a proof of payment. The service terminal of the buyer's bank 2 may further send the proof of payment to the user terminal of the buyer 1. The service terminal of the buyer's bank 2 may further store the expiration date for the proof of payment, the seller's name, and the payment amount. If the service terminal of the buyer's bank 2 does not approve the payment request, the service terminal of the buyer's bank 2 may send a message to the user terminal of the buyer 1, indicating the request has been denied. The service terminal of the buyer's bank 2 may further receive the seller's name, payment amount from the service terminal of the seller's bank 4. The service terminal of the buyer's bank 2 may determine whether the information received from the service terminal of the seller's bank 4 is consistent with the seller's name, payment amount, etc. stored in the service terminal of the buyer's bank 2. The service terminal of the buyer's bank 2 may further determine whether the proof of payment has expired. If not, the service terminal of the buyer's bank 2 may release the payment funds and send the payment to the service terminal of the seller's bank 4. Otherwise, the service terminal of the buyer's bank 2 may inform the service terminal of the seller's bank 4 that its withdrawal has failed. The service terminal of the seller's bank 4 may inform the service terminal of the seller 3 that the payment has failed.

In some embodiments, the service terminal of the buyer's bank 2 may generate the proof of payment including a bank ID and a random number sequence. In some embodiments, the user terminal of the buyer 1 may use its account number and password to log in and then send a request for payment including the seller's name and payment amount to the service terminal of the buyer's bank 2. The service terminal of the buyer's bank 2 may determine whether to approve the payment request depending on the buyer's account number and password.

The service terminal of the buyer's bank 2 may further obtain information that is unique to the user terminal of the buyer 1. The service terminal of the buyer's bank 2 may determine whether to approve the payment request depending on the buyer's account number, password, and information unique to the buyer's user terminal 1.

The unique user terminal information may include the IP address of the user terminal, the previous logging in time of the user terminal, the serial number of the buyer's user terminal, a pre-set random number stored in the buyer's user terminal, the mobile phone number of the user terminal (if the user terminal is on a mobile phone), the MAC address of the user terminal (if the user terminal is on a PC), or any combination thereof.

The service terminal of the seller's bank 4 may send the seller's name, and payment amount, and the proof of payment to the service terminal of the buyer's bank 2. After the service terminal of the buyer's bank 2 makes the payment, the service terminal of the seller's bank 4 may send a message to the user terminal of the seller 3 indicating whether the funds were successfully withdrawn from the buyer's bank. The user terminal of the seller 3 may then send the message indicating whether a payment is made successfully to the user terminal of the buyer 1.

In some embodiments, the service terminal of the seller's bank 4 may send the buyer's bank account, the proof of payment, the seller's name, and the payment amount to the service terminal of the buyer's bank 2. In some embodiments, encryptions and signatures may be applied to the communications between the user terminal of the buyer and the buyer's bank, between the user terminal of the buyer and the user terminal of the seller, between the user terminal of seller and the seller's bank, and between the seller's bank and the user terminal of the buyer. This is to ensure that the information transferred between the different entities is secure and reliable. When the buyer opens an account at the buyer's bank, the user terminal of the buyer land the service terminal of the buyer's bank 2 may exchange a security key, which may be subsequently used to encrypt information transferred between the user terminal 1 and the bank 2.

Other aspects of the embodiments consistent with the present disclosure are also discussed in relation to FIG. 4 and can be understood by those skilled in the art.

In embodiments consistent with the present disclosure the user terminal of the buyer may use the buyer's account and password to log into a secure payment system and send a request for payment to the buyer's bank. The request includes the identification of the seller and the payment amount requested. The service terminal of the buyer may further receive a proof of payment from the buyer's bank. The service terminal of the buyer may send the proof of payment to the user terminal of the seller. The service terminal of the buyer's bank may determine whether it should approve the payment request. If so, the service terminal of the buyer's bank may withhold the payment amount from the buyer's account and generate a proof of payment. The service terminal of the buyer's bank may further send the proof of payment to the user terminal of the buyer. The service terminal of the buyer's bank may further store the expiration date for the proof of payment, the seller's name, and the payment amount. If the buyer's bank does not approve the payment request, the service terminal of the buyer's bank may send a message to the user terminal of the buyer, indicating the request has been denied. The service terminal of the buyer's bank may further receive the seller's name, payment amount from the service terminal of the seller's bank. The service terminal of the buyer's bank may determine whether the information received from the service terminal of the seller's bank is consistent with the seller's name, payment amount, etc. stored in the service terminal of the buyer's bank. The service terminal of the buyer's bank may further determine whether the proof of payment has expired. If not, the service terminal of the buyer's bank may release the hold on the payment amount and send the payment to the service terminal of the seller's bank. Otherwise, the service terminal of the buyer's bank may inform the service terminal of the seller's bank that its withdrawal has failed. The service terminal of the seller's bank may inform the service terminal of the seller that the payment has failed.

The service terminal of the buyer's bank may generate the proof of payment including a bank ID and a random number sequence. The user terminal of the buyer may use its account number and password to log in and then send a request for payment including the seller's name and payment amount to the service terminal of the buyer's bank. The service terminal of the buyer's bank may determine whether to approve the payment request depending on the buyer's account number and password. The service terminal of the buyer's bank may further obtain information that is unique to the user terminal of the buyer. The service terminal of the buyer's bank may determine whether to approve the payment request depending on the buyer's account number, password, and information unique to the buyer's user terminal.

The service terminal of the buyer's bank may determine whether it should approve the payment request. If so, the service terminal of the buyer's bank may hold the payment amount from the buyer's account and generate a proof of payment. The service terminal of the buyer's bank may further send the proof of payment to the user terminal of the buyer 1. The service terminal of the buyer's bank may further store the expiration date for the proof of payment, the seller's name, and the payment amount. If the buyer's bank does not approve the payment request, the service terminal of the buyer's bank may send a message to the user terminal of the buyer, indicating the request is denied.

The service terminal of the buyer's bank may further receive seller's name, payment amount from the service terminal of the seller's bank. The service terminal of the buyer's bank may determine whether the information received from the service terminal of the seller's bank is consistent with the seller's name, payment amount, etc. stored in the service terminal of the buyer's bank. The service terminal of the buyer's bank may further determine whether the proof of payment has expired. If not, the service terminal of the buyer's bank may release the hold on the payment amount and send the payment to the service terminal of the seller's bank. Otherwise, the service terminal of the buyer's bank may inform the service terminal of the seller's bank that its withdrawal has failed.

In embodiments consistent with the present disclosure, only the proof of payment is being transferred between the parties. The buyer's account information does not need to be passed on to the seller. Further, the proof of payment has an expiration date, which adds security to the payment process. In addition, because the user terminal of the seller and the buyer's bank does not exchange information directly, the buyer's bank does not need to authenticate the seller. This simplifies the payment process and makes the process more secure.

Consistent with embodiments of the present disclosure, one or more non-transitory storage medium storing a computer program are provided to implement the system and method for making secure payments. The one or more non-transitory storage medium may be installed in a computer or provided separately from a computer. A computer may read the computer program from the storage medium and execute the program to perform the methods consistent with embodiments of the present disclosure. The storage medium may be a magnetic storage medium, such as hard disk, floppy disk, or other magnetic disks, a tape, or a cassette tape. The storage medium may also be an optical storage medium, such as optical disk (for example, CD or DVD). The storage medium may further be semiconductor storage medium, such as DRAM, SRAM, EPROM, EEPROM, flash memory, or memory stick.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

What is claimed is:

1. A service terminal of a buyer's bank implementing a method for secure payment, the service terminal being configured to:
receive a request for payment from a buyer, the request including a name of a seller and a payment amount;
approve the request for payment;
withhold the payment amount;
generate a proof of payment;
store the proof of payment, an expiration date of the proof of payment, the name of the seller and the payment amount;
send the proof of payment to the buyer;
receive a withdrawal request from a seller's bank, the withdrawal request including the proof of payment, the name of the seller, and the payment amount; and
move the buyer's funds based on the withdrawal request.

2. The service terminal according to claim 1, wherein the service terminal is further configured to:
determine whether to release the payment to the seller's bank based on the withdrawal request.

3. The service terminal according to claim 2, wherein the proof of payment includes a buyer's bank ID and a random sequence number.

4. The service terminal according to claim 3, wherein the buyer, using a user ID and a password, logs into a secure payment system through a user terminal before sending the payment request.

5. The service terminal according to claim 4, wherein the buyer's bank approves the request for payment based on the user ID and password.

6. The service terminal according to claim 5, wherein the buyer's bank requires information unique to the user terminal of the buyer.

7. The service terminal according to claim 6, wherein the buyer's bank approves the request for payment based on the user ID, the password, and the information unique to the user terminal of the buyer.

8. The service terminal according to claim 6, wherein the information unique to the user terminal of the buyer is an IP address of the user terminal of the buyer, a previous log-in time of the user terminal of the buyer, a random number sequence stored in the user terminal of the buyer, a mobile phone number, an MAC address, or a combination thereof.

9. A system for secure payment, including a buyer user terminal, a service terminal of the buyer's bank, a seller user terminal, and a service terminal of the seller's bank, wherein:
the buyer terminal is configured to send a request for payment to the service terminal of the buyer's bank, the request including a name of a seller and a payment amount;
the service terminal of the buyer's bank is configured to approve the request for payment;
the service terminal of the buyer's bank is configured to withhold the payment amount, generate a proof of payment, store the proof of payment and an expiration date of the proof of payment; and send the proof of payment to the buyer;
the user terminal of the buyer is configured to send the proof of payment to the user terminal of the seller;
the user terminal of the seller is configured to send the proof of payment to the service terminal of the seller's bank;
the service terminal of the seller's bank is configured to send a withdrawal request to the buyer's bank, the withdrawal request including the proof of payment, the name of the seller and the payment amount;
the service terminal of the buyer's bank is configured to move the buyer's funds based on the withdrawal request; and
the service terminal of the seller's bank is configured to inform the user terminal of the seller the payment is fulfilled.

10. The system according to claim 9, wherein the service terminal of the buyer's bank is being configured to:
determine whether to release the payment based on the withdrawal request.

11. The system according to claim 10, wherein the proof of payment includes a buyer's bank ID and a random sequence number.

12. The system according to claim 11, wherein the user terminal of the buyer logs into a secure payment system using a user ID and a password before sending the payment request.

13. The system according to claim 12, wherein the service terminal of the buyer's bank approves the request for payment based on the user ID and password.

14. The system according to claim 13, wherein the service terminal of the buyer's bank requires information unique to the user terminal of the buyer.

15. The system according to claim 14, wherein the service terminal of the buyer's bank approves the request for payment based on the user ID, the password, and the information unique to the user terminal of the buyer.

16. The system according to claim 15, wherein the information unique to the user terminal of the buyer is an IP address of the user terminal of the buyer, a previous log-in time of the buyer, a random number sequence stored in the user terminal of the buyer, a mobile phone number, an MAC address, or a combination thereof.

17. A system for secure payment, including a buyer user terminal, a service terminal of the buyer's bank, a seller user terminal, and a service terminal of the seller's bank, wherein the service terminal of the seller's bank is configured to:
receive a proof of payment from the user terminal of the seller, the proof of payment being received with a name of the seller and a payment amount;
send the proof of payment to the service terminal of the buyer's bank, requesting withdrawal of the payment amount;
receive a message from the service terminal of the buyer's bank, indicating the withdrawal is complete; and
send a message to the user terminal of the seller, indicating the payment is collected.

18. The system according to claim 17, wherein the proof of payment further includes the ID of the buyer's bank and a random number sequence.

19. The system according to claim 18, wherein the random number sequence reflects the ID of the buyer's bank and an ID of the proof of payment.

20. A method for making secure payments, comprising:
receiving a request for payment from a buyer, the request including a name of a seller and a payment amount;
approving the request for payment;
withholding the payment amount;
generating a proof of payment;
storing the proof of payment, an expiration date of the proof of payment, the name of the seller and the payment amount;
sending the proof of payment to the buyer;
receiving a withdrawal request from a seller's bank, the withdrawal request including the proof of payment, the name of the seller, and the payment amount; and
moving the buyer's funds based on the withdrawal request.

21. The method according to claim 20, further comprising:
determining whether to release the payment to the seller's bank based on the withdrawal request.

22. The method according to claim 21, wherein the proof of payment includes a buyer's bank ID and a random sequence number.
